(19) United States
(12) Patent Application Publication
(10) Pub. No.: US 2001/0021187 A1
(43) Pub. Date: Sep. 13, 2001

(54) Multidimensional crossbar network and parallel computer system

(76) Inventors: Yuji Saeki, Ebina (JP); Masaya Nakahata, Sagamihara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/761,743

(22) Filed: Jan. 18, 2001

(30) Foreign Application Priority Data
Mar. 10, 2000 (JP) 2000-072458

(51) Int. Cl. H04L 12/56

(52) U.S. Cl. 370/389; 370/406

(57) ABSTRACT

A three-dimensional crossbar network of a distributed exchanger type for connecting L×M×N arithmetic units, in which an interface conversion LSI 32 for transferring a packet to a Z axis crossbar switch 41 is provided between an X axis crossbar switch 21 and a Y axis crossbar switch 31. The interface conversion LSI 32 has an optical module 33 so that an optical fiber 300 can be applied as a packet transfer path between the Y axis crossbar switch and the Z axis crossbar switch.

### BACKGROUND OF THE INVENTION

(1) Field of the Invention

The present invention relates to a multidimensional crossbar network and a multidimensional parallel computer system and, more particularly, a network configuration for connecting a number of arithmetic units.

(2) Description of the Related Art

As a system for executing a computing process of an enormous amount at high speed, for example, a parallel computer system having a configuration in which a number of processor nodes are connected to each other via a network is known. Each of the processor nodes can be a multiprocessor type computer obtained by tightly coupling a plurality of arithmetic units.

Many parallel computer systems are of a distributed memory type in which a memory is disposed for each of processor nodes multidimensionally arranged and each of the processor nodes copies a part of data necessary for calculation from a memory of another node into its memory.

A program rewritten from a shared memory model so as to operate on the parallel computer of the distributed memory type is adapted to a model in which all of the nodes operate by the same program with different data. With respect to communication among nodes, for example, when it is seen from one of a pair of nodes performing communications, a relative position of the other node and a communication data amount are often fixed in each node pair (isotropic data transfer) The most basic data access in the shared memory model has a pattern of accessing data with addresses continuous in the memory space. When the basic pattern is applied as it is to distributed memories, data transfer between adjacent nodes (adjacent data transfer) appears most frequently.

In the parallel computer system of this kind, it is necessary to construct a network connecting processor nodes so that communication can be performed between two arbitrary nodes. At present, a parallel computer system constructed by few hundreds to few thousands of processor nodes can be realized by a network configuration of, for example, a mesh type, a torus type, a multidimensional crossbar type, a simple crossbar type, or the like.

In the network configurations of the “mesh type” and the “torus type”, when multidimensional logical coordinates are provided on each of the processor nodes, the network directly connects only between processor nodes in positions neighboring to each other in the coordinate space. If a number of processor nodes can be physically arranged in correspondence with logical coordinates, there is an advantage such that a very large number of processor nodes can be connected to each other with short wire length. However, in the network configuration of this type, although transfer between the neighboring processor nodes can be performed without path congestion, path congestion occurs during communication between nodes which are not adjacent to each other in a calculating process using frequently the isotropic data transfer which accesses data of a node which is not neighboring, so that the effective performance of the system deteriorates. The parallel computer of the mesh type and that of the torus type are adapted to large-scale computation for a specific application but lack generality.

In the network configuration of the “simple crossbar type”, packet communications can be simultaneously performed among a plurality of arbitrary pairs of nodes. Consequently, calculating process using the isotropic data transfer for globally accessing data distributed to processor nodes can be efficiently executed with little communication loss between nodes. In the network of the simple crossbar type, when a group of LSIs constructing a crossbar switch is concentratedly disposed in a position, a wire connecting each processor node and the crossbar switch becomes long.

The network of the “multidimensional crossbar type” has a logical structure which is intermediate of the above two types, can relatively efficiently perform global communication between nodes, and can scalably increase the number of connecting nodes and the system performance. The multidimensional crossbar network has a logical configuration such that, for example, when the number of dimensions is three, a processor node is preliminarily mapped in lattice points of a rectangular parallelepiped of L×M×N, a multistage crossbar switch is constructed by a crossbar switch connecting L nodes arranged in the X axis direction, a crossbar switch connecting M nodes arranged in the Y axis direction, and a crossbar switch connecting N nodes arranged in the Z axis direction, and a memory in a node and a switch called an exchanger for selectively connecting each node to each of the crossbar switches in the X, Y, and Z axis directions are provided for each processor node.

In the multidimensional crossbar network, however, the exchanger provided for each node needs three lines to be selectively connected to the crossbar switches in the X, Y, and Z axis directions. Consequently, long distance concentrated wiring is made in any of the lines.

For example, the X axis crossbar switch and the L processor nodes connected to the X axis crossbar switch are mounted on the same board, M boards each including a group of nodes having the same Z coordinate are housed in the same back board, and the M nodes having the same X coordinate are connected by L pieces of Y axis crossbar switches mounted on the back board, thereby forming a network of the group of two-dimensionally arranged nodes by relatively short wires. A three-dimensional node array of L×M×N constructed by N two-dimensional node arrays is obtained by connecting the total L×M×N nodes dispersively disposed in N back boards to any ports of the Z axis crossbar switches of L×M arrays.

The multidimensional crossbar type needs the smaller number of connection ports of LSIs constructing the crossbar switch in each axis direction as compared with the simple crossbar type, so that designing is easy. By dispersively disposing the LSI groups for crossbar switches and processor node groups to some boards and carrying out wiring partially on each board, concentration of wiring from the processor nodes to the crossbar switches as in the simple crossbar type can be avoided. However, in the case of concentratedly disposing the Z axis crossbar switch groups in the L×M arrays in a position, a long line is necessary to connect each of the processor nodes on the backboard and the Z axis crossbar switch.

A network configuration obtained by improving the multidimensional crossbar type is known as a multidimensional crossbar network of a “distributed exchanger type” in which the exchanger function as a wiring source to the X, Y, and Z axis directions is divided, each processor node is provided with a function of connecting the processor node and the X axis crossbar switch, the X axis crossbar switch is provided with a function of connecting the X axis crossbar switch and the Y axis crossbar switch, and the Y axis crossbar switch is provided with a function of connecting the Y axis crossbar switch and the Z axis crossbar switch. According to the distributed exchanger type, a network can be constructed in a connection form such that lines each sequentially connecting a processor node and the X and Y axis crossbar switches are converged to Z axis crossbar switches.

### SUMMARY OF THE INVENTION

In the multidimensional crossbar network configuration of the distributed exchanger type, however, since the lines connecting the Y axis crossbar switch and the Z axis crossbar switch become longer according to the system scale, the number of processor nodes which can be connected and the system performance are limited according to electrical characteristics of a connection cable.

In the multidimensional crossbar network of the distributed exchanger type, a crossbar switch in each axis direction other than the most significant axis (Z axis in the case of the three dimensions) is provided with the function of connecting the crossbar switch to a crossbar switch in another axis direction. Consequently, it requires external connection pins (LSI pins) twice as many as those of a crossbar switch in a regular multidimensional crossbar network in which each processor node has the exchanger function.

For example, in the regular multidimensional crossbar network configuration, in the case of connecting L×M×N nodes, it is sufficient for the Y axis crossbar switch to have M sets of input/output ports equal to the number of nodes in the Y axis direction. On the other hand, the Y axis crossbar switch in the distributed exchanger type needs M sets of input/output ports for connection to the X axis crossbar switch and M sets of input/output ports for connection to the Z axis crossbar switch. When external connection pins of LSIs of the same number are used, the number of nodes which can be arranged in the Y axis direction is the half of the number in the regular multidimensional crossbar type.

In the crossbar network of the distributed exchanger type, even in the case of performing communication between two nodes neighboring to each other in the Z axis direction, a packet cannot reach the Z axis crossbar switch without passing through the X and Y axis crossbar switches. Consequently, there is a problem such that, in communication of the adjacent data transfer which appears most frequently, required time for a transmission packet to reach a destination node becomes long according to the positional relation of neighboring nodes.

It is an object of the invention to provide a multidimensional crossbar network of a distributed exchanger type and a parallel computer system capable of extending a system scale (the number of connectable nodes) while suppressing an increase in node connecting costs.

Another object of the invention is to provide a multidimensional crossbar network of a distributed exchanger type and a parallel computer system in which characteristic deterioration in a long-distance wiring section is little.

Further another object of the invention is to provide a multidimensional crossbar network of a distributed exchanger type and a parallel computer system with the increased number of nodes which can be accommodated per crossbar switch.

In order to achieve the object, according to the invention, there is provided a multidimensional crossbar network in which a plurality of processor nodes logically, multidimensionally arranged are connected to each other via a plurality of crossbar switches, wherein a switching device connected to first and second crossbar switches and a third crossbar switch is provided on each packet transmission path connecting the first and second crossbar switches, and by the switching device, a packet is exchanged among the first, second, and third crossbar switches, and interface conversion for performing packet communication by a light signal with any of the crossbar switches is performed.

According to the invention, by providing the switching device (LSI) connecting crossbar switches with an interface conversion function for performing packet communication by a light signal, packet communication can be carried out in a long-distance wiring interval. In this case, by processing packets transmitted and received by an electric signal cable connection port and packets transmitted/received by a light signal cable (optical fiber) connection port with differently synchronized clock signals independent of each other, a communication form adapted to the optical signal transmission can be used in the long-distance wiring interval.

In the invention, for example, the switching device is applied as a packet branching switch for transferring a reception packet between crossbar switches of different coordinate axes to a crossbar switch of another coordinate axis.

As an embodiment of the invention, there is provided a multidimensional crossbar network and a parallel computer system having a plurality of X, Y, and Z axis crossbar switches for connecting a plurality of processor nodes logically, multidimensionally arranged to each other, wherein a switching device for selectively transferring reception packets from the X axis and Y axis crossbar switches to the Z axis crossbar switch is provided on each packet transmission path between the X axis crossbar switch and the Y axis crossbar switch.

With the configuration, the transfer to the Z axis crossbar switch is executed on the outside of the Y axis crossbar switch. Consequently, connection pins to the Z axis crossbar switches are unnecessary for the Y axis crossbar switch LSI, and the connection pins can be effectively used as those for connection to the X axis crossbar switches. In the case of performing communication between nodes neighboring in the Z axis direction, a packet can be transferred from the X axis crossbar switch to the Z axis crossbar without passing through the Y axis crossbar switch. Consequently, required time for the communication packet to reach the destination node can be shortened.

In the invention, the switching device is also applied as, for example, a switch for exchanging packets between different multidimensional crossbar networks. As a second embodiment of the invention, there is provided a multidimensional crossbar network comprised of first and second crossbar networks in each of which a plurality of processor nodes multidimensionally arranged are connected to each other via a plurality of X, Y, and Z axis crossbar switches, wherein each of said crossbar networks has: a plurality of X axis crossbar switches for performing packet exchange in the X axis direction among a plurality of processor nodes having the same Y, Z coordinate values in a three-dimensional coordinate system; a plurality of Y axis crossbar switch groups for performing packet exchange in the Y axis direction among a plurality of X axis crossbar switches accommodating processor nodes having the same Z coordinate value in a three-dimensional coordinate system; and a plurality of Z axis crossbar switches for performing packet exchange in the Z axis direction between the plurality of Y axis crossbar switch groups, two Y axis crossbar switches in positions corresponding to each other in the first and second crossbar networks are coupled to each other via a plurality of switching LSIs disposed on each of packet paths between the Y axis crossbar switches and Z axis crossbar switches, and packet exchange between the first and second crossbar networks is performed by each of the switching LSIs.

In this case, to be specific, each of the switching LSIs has: first and second input/output ports for communicating packets with the two Y axis crossbar switches; third and fourth input/output ports for communicating packets with first and second optical modules each having a light-emitting element and a light-receiving element; and means for selectively outputting reception packets from the first and second input/output ports to the other one of the first and second input/output ports or the third or fourth input/output port in accordance with header information, and transferring reception packets from the third and fourth input/output ports to the first and second input/output ports, respectively, and a part of a packet transmission path between each of the Y axis crossbar switches and each of the Z axis crossbar switches is made by an optical fiber coupled to each of the optical modules.

In the invention, for example, the switching device is also applied as a packet exchanging switch which replaces a crossbar switch of a specific axis in a multidimensional crossbar network. As a third embodiment of the invention, there is provided a multidimensional crossbar network comprising: a plurality of X axis crossbar switches for performing packet exchange in the X axis direction among a plurality of processor nodes having the same Y, Z coordinate values in a three-dimensional coordinate system; a plurality of Y axis crossbar switch groups for performing packet exchange in the Y axis direction among a plurality of X axis crossbar switches accommodating processor nodes having the same Z coordinate value in a three-dimensional coordinate system; and a plurality of Z axis crossbar switching means for performing packet exchange in the Z axis direction between the plurality of Y axis crossbar switch groups, wherein each of the Z axis crossbar switching means comprises: a first group of switching LSIs each having a first input/output port group connected to input/output ports in corresponding X axis coordination positions of a plurality of Y axis crossbar switches having the same X axis coordinate value in a three-dimensional coordinate system, and a second input/output port group connected to a plurality of optical modules each including a light-emitting element and a light-receiving element; a second group of switching LSIs each having a first input/output port group connected to input/output ports in corresponding X axis coordinate positions in other plurality of Y axis crossbar switches having the same X axis coordinate value in a three-dimensional coordinate system, and a second input/output port group connected to a plurality of optical modules each including a light-emitting element and a light-receiving element; and plural pairs of optical fibers coupled between the second input/output port group in the first group of switching LSIs and the second input/output port group in the second group of switching LSIs via optical modules. With the configuration, the three-dimensional crossbar network can be constructed while suppressing the node connecting cost.

The other objects and features of the invention will become apparent from the following description of the embodiments with reference to the accompanying drawings.

### BRIEF DESCRIPTION OF THE DRAWINGS

FIG. 1 is a diagram for explaining connecting relations among X, Y, and Z axis crossbar switches in a three-dimensional crossbar network of a distributed exchanger type according to the invention.

FIG. 2 is a diagram showing the configuration of a node board 10 on which a processor node is mounted.

FIG. 3 is a diagram showing the connecting relation between an X axis crossbar switch and a Y axis crossbar switch in a three-dimensional crossbar network of a distributed exchanger type of the invention.

FIG. 4 is a diagram showing the connecting relation between the Y axis crossbar switch and a Z axis crossbar switch in the three-dimensional crossbar network in the distributed exchanger type of the invention.

FIG. 5 is a block diagram showing the configuration of an interface conversion LSI 32.

FIG. 6 is a diagram showing an example of a practical form of the interface conversion LSI 32.

FIG. 7 is a diagram showing the main portion of the Y axis crossbar switch.

FIG. 8 is a diagram showing a modification of the Y axis crossbar switch.

FIG. 9 is a diagram showing a second embodiment of the three-dimensional crossbar network of the exchanger type according to the invention.

FIG. 10 is a diagram showing an embodiment of a switching LSI 80 in FIG. 9.

FIG. 11 is a diagram showing a third embodiment of the three-dimensional crossbar network of the exchanger type according to the invention.

### DESCRIPTION OF THE PREFERRED EMBODIMENTS

Embodiments of the invention will be described hereinbelow with reference to the drawings.

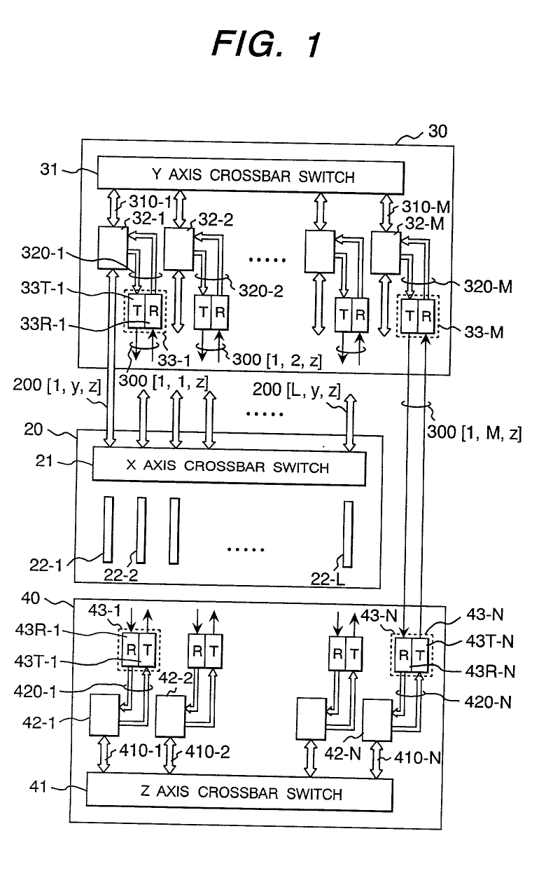

FIG. 1 is a diagram for explaining the connecting relations among X, Y, and Z axis crossbar switches in a three-dimensional crossbar network of the distributed exchanger type according to the invention. Shown in the diagram are an X axis board 20 on which an X axis crossbar switch (LSI) 21 is mounted, a Y axis board 30 on which a Y axis crossbar switch (LSI) 31 is mounted, and a Z axis board 40 on which a Z axis crossbar switch (LSI) 41 is mounted.

In the case of constructing a three-dimensional crossbar network connecting L×M×N nodes, L node boards 10 corresponding to coordinate values on the X axis are accommodated on the X axis board 20. 22-1 to 22-L denote connectors for connecting the node boards. Each connector 22 is coupled to an input/output port of the X axis crossbar switch 21 by printed wiring formed on the surface of or in the X axis board.

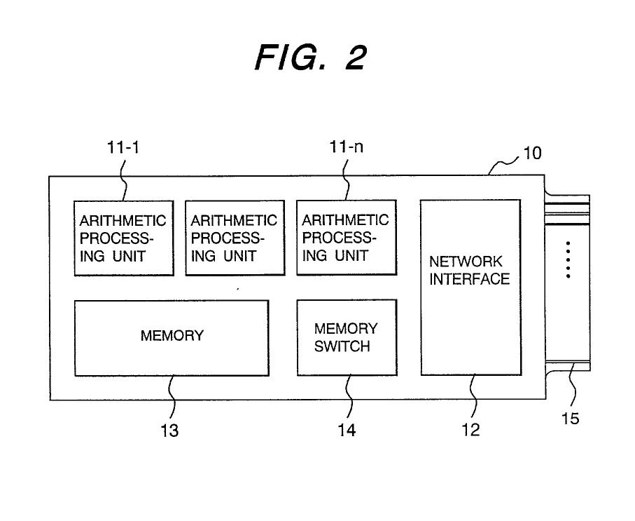

Each node board 10 has, as shown in FIG. 2, arithmetic processing units 11 constructed by a plurality of LSIs, a network interface LSI 12, a memory LSI 13 commonly used by the LSIs, and a memory switch 14. A processor node is formed by the above circuit elements. Reference numeral 15 denotes a lead terminal group provided at an end of the board. By inserting the lead terminals to the connector 22-i on the X axis board 20, the processor node is connected to a predetermined input/output port of the X axis crossbar switch 21.

When data is transmitted to another processor node, each of the arithmetic processing units 11 sets transmission data and control information in a predetermined area in the memory 13 and, after that, activates the network interface LSI 12. The activated network interface LSI 12 reads out the transmission data in accordance with the control information prepared in the memory 13, generates a packet having, for example, an 8-byte width, and transmits the packet to the X axis crossbar switch 21. In the header portion of the packet, X, Y, and Z coordinate values indicative of a destination node position in the three-dimensional crossbar network are set as a destination address.

Paying attention to a packet having a destination address [i, j, k] , a transferring operation on the three-dimensional crossbar network of FIG. 1 will be described hereinbelow.

The X axis crossbar switch 21 has not only L input/output ports for accommodating the node boards (processor nodes) 10 but also L external input/output ports for accommodating connection lines to the Y axis crossbar switch 31. For the connection between the X axis crossbar switch 21 and the Y axis crossbar switch 31, input/output lines 200 [1, y, z] to 200 [L, y, z] which are, for example, coaxial lines are used.

Characters and numerals in brackets denote an address (X, Y, and Z coordinate values) of a processor node in the three-dimensional crossbar network. For example, to the input/output line 200 [1, y, z], either a transmission packet which is outputted from a processor node having an address [1, y, z] connected to the connector 22-1 to another processor node or a reception packet from another processor node to the processor node having the address [1, y, z] is supplied. Coordinate values [y, z] are Y, Z coordinate values common to the group of processor nodes accommodated in the X axis crossbar switch 21. The coordinate values [y, z] are preset as a board address in the X axis crossbar switch.

When a packet having a destination address [i, j, k] is received from any of processor nodes accommodated, the X axis node switch 21 switches to the i-th port in accordance with the destination X coordinate of the packet header. The destination Y, Z coordinates j, k of the reception packet are compared with the X axis board address. A reception packet required to be switched on the Y axis or Z axis is transmitted to the external input/output line of the i-th port, for example, 200 [i, y, z] (i=destination X coordinate value). A packet whose destination Y, Z coordinate values j, k coincide with the board address [y, z] and which is not required to be switched on the Y or Z axis is transmitted to the node board side of the i-th port (connector 22-i).

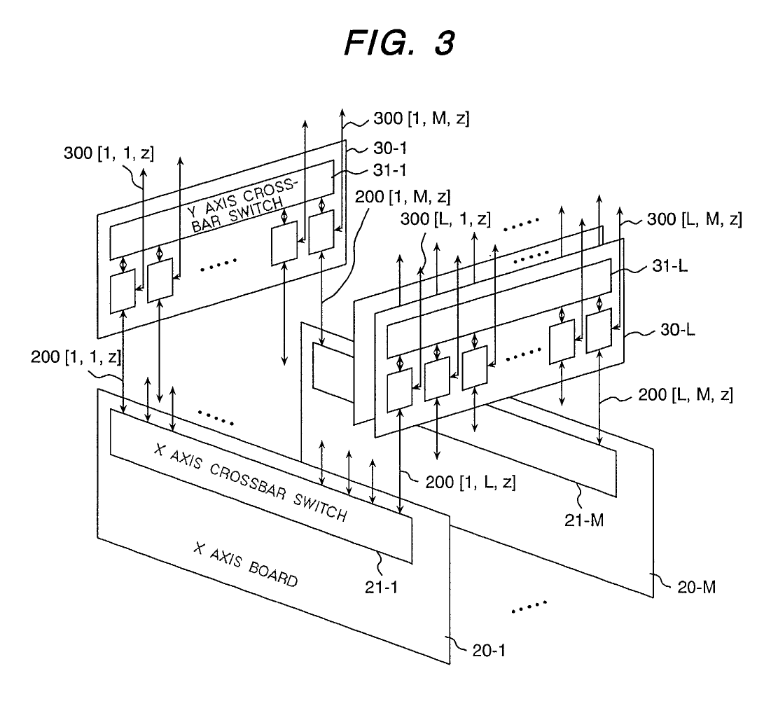

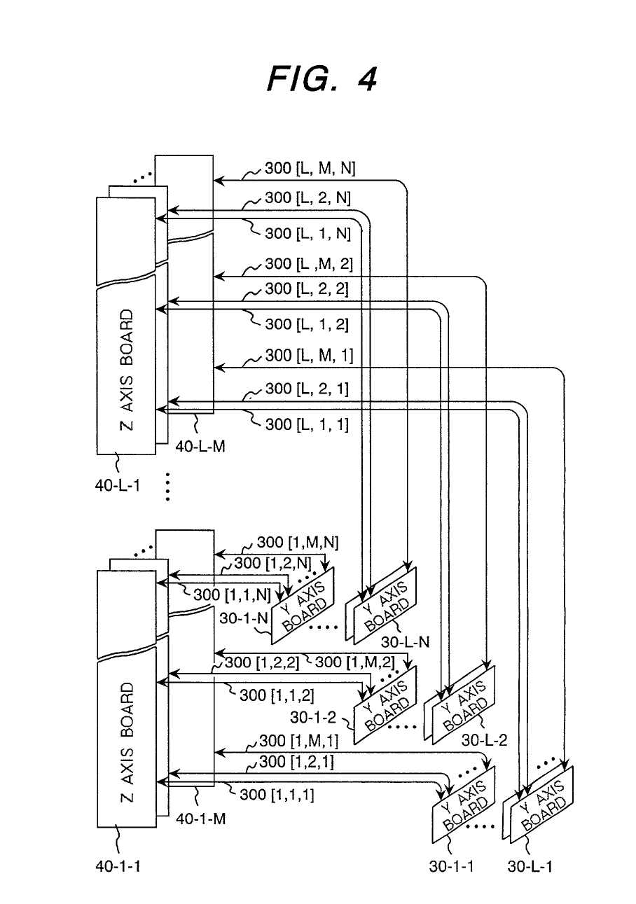

As will be described in FIGS. 3 and 4, L pieces of the Y axis boards 30 are prepared in correspondence with the X coordinate for each Z coordinate value of the three-dimensional crossbar network, and specific X, z coordinate values are designated as board addresses to the Y axis boards 30. On each of the Y axis boards, the Y axis crossbar switch 31 and M switching LSIs 32-1 to 32-M corresponding to the Y coordinate of the three-dimensional crossbar network are mounted.

In the embodiment, each switching LSI 32 is used to branch the packet into the Z axis crossbar switch direction between the X axis and Y axis crossbar switches and to perform interface conversion for light transmission on the branched packet. The switching LSI 32 will be called an interface conversion LSI in the following description.

A packet transmitted from the X axis crossbar switch 21 to the input/output line 200 [i, y, z] is supplied to the y-th interface conversion LSI 32-y on the Y axis board 30 having X, Z coordinate values [i, z] as a board address. The interface conversion LSI 32-y checks the destination address of the reception packet from the input/output line 200 [i, y, z] and transmits a packet which is not required to be switched on the Y axis, that is, a packet whose destination Y coordinate value j coincides with the Y coordinate y of the interface conversion LSI 32-y to an input/output line 320-y (=320-j) connected to an optical module 33-y constructed by a laser light emitting element 33T-y and a light-receiving element 33R-y. The interface conversion LSI 32-y outputs a packet which is required to be switched on the Y axis, that is, a packet whose destination Y coordinate value (j) does not coincide with the Y coordinate value (y) of the interface conversion LSI to an input/output line 310-y connected to the Y axis crossbar switch 31.

A packet outputted to the input/output line 310-y is switched to the j-th interface conversion LSI 32-j corresponding to the destination Y coordinate value (j) by the Y axis crossbar switch 31. The interface conversion LSI 32-j checks the destination address of the reception packet from the Y axis crossbar switch 31, outputs a packet which is not required to be switched on the Z axis, that is, a packet whose destination Z coordinate value (k) coincides with the z coordinate value (z) of the Y axis board address to the input/output line 200 [i, j, z], and outputs a packet which is required to be switched on the Z axis to the input/output line 320-j.

The packet outputted to the input/output line 320 is converted to a light signal by the laser light emitting element 33T-j and the light signal is transmitted to an input/output line (optical fiber) 300 [i, j, z]. The input/output line (optical fiber) 300 [i, j, k] is connected to the Z axis board 40 having the X, Y coordinate values [i, j] as a board address.

Each of the Z axis boards 40 has the Z axis crossbar switch 41 and N pieces of interface conversion LSIs 42-1 to 42-N corresponding to the Z coordinate value of the three-dimensional crossbar network, Each interface conversion LSI 42-q (q=1 to N) has an input/output line 410-q connected to the Z axis crossbar switch 41 and an input/output line 420-q connected to an optical module 43-q including a laser light emitting element 43T-q and a light-receiving element 43R-q.

Different from the interface conversion LSI 32 on the Y axis board 30, the input/output ports of each of the interface conversion LSIs 42 on the Z axis board 40 are for two sides of the Z axis crossbar switch side and the optical module side. A packet transmitted as a light signal from the Y axis board 30 to the input/output line (optical fiber) 300 [i, j, z] is converted to an electric signal by a light-receiving element 43R-z on the Z axis board 40 side. After that, the electric signal is unconditionally transferred to the input/output line 410-z and is supplied to the Z axis crossbar switch 41. The Z axis crossbar switch 41 switches the packet to the k-th interface conversion LSI 42-k corresponding to the destination Z coordinate value k.

The k-th interface conversion LSI 42-k transfers the input packet from the Z axis crossbar switch 41 to an input/output line 420-k. The packet is therefore converted to a light signal by a laser light emitting element 43T-k, and the light signal is transmitted to the optical fiber 300 [i, j, k]. The optical fiber 300 [i, j,k] is connected to an optical module of the j-th interface conversion LSI 32-j on the Y axis board 30 having the X, Z coordinate values [i, k] as a board address. By this time, the destination x, z coordinates of the reception packet already coincide with the board address [i, k] on the Y axis board, and the destination Y coordinate j coincides with the address j of the j-th interface conversion LSI 32-j. Consequently, it is unnecessary to switch the packet by the Y axis crossbar switch 31. The reception packet is therefore outputted to the input/output line 200 [i, j, k] by the j-th interface conversion LSI 32-j on the Y axis board.

The input/output line 200 [i, j, k] is connected to the X axis crossbar switch 21 on the X axis board 20 having the Y, Z coordinate values [i, k] as a board address. When the packet is received from the input/output line 200 [i, j, k] the X axis crossbar switch 21 transmits the packet to the i-th port to which the i-th connector 22-i is connected. In such a manner, the packet is received by the processor node corresponding to the destination address [i, j, k] of the packet header.

FIG. 3 shows a connecting relation between the X axis crossbar switch group and the Y axis crossbar switch group having the same z coordinate value (z). To simplify the drawing, an optical module connected to each of the interface conversion LSIs is not shown.

A two-dimensional crossbar network having X-Y planes in a three-dimensional crossbar network constructed by L×M×N processor nodes is comprised of M pieces of X axis boards 20-1 to 20-M prepared in correspondence with the Y coordinate values and L pieces of Y axis boards 30-1 to 30-L prepared in correspondence with the X coordinate values. In L×M external input/output ports formed in M pieces of X axis crossbar switches 21-1 to 21-M on the X axis boards 20-1 to 20-M, M input/output ports having the same X coordinate value (i) are connected to the crossbar switches 31-i on the Y axis board 30-i having the board address [i, z] via the input/output lines 200 [i, 1, z] to 200 [i, M, z].

Addresses corresponding to the input/output lines 200 [i, 1, z] to 200 [i, M, z] connected to interface conversion LSIs on the Y axis boards 30-1 to 30-L can be assigned to the interface conversion LSIs. In the following description, the interface conversion LSI connected to the line 200 [i, j, z] on the Y axis board 30-i will be indicated by reference numeral 32 [i, j, z], and the light signal input/output line (optical fiber) connected to optical modules 33 and 34 of the interface conversion LSI will be indicated by reference numeral 300 [i, j, z].

FIG. 4 shows the connecting relation between the Z axis board 40 and the Y axis board 30 combining a plurality of X-Y planes. In the drawing, 30-1-1 to 30-L-1 denote a group of Y axis boards having the Z coordinate value of “1”, 30-1-2 to 30-L-2 indicate a group of Y axis boards having the Z coordinate value of “2”, and 30-1-N to 30-L-N denote a group of Y axis boards having a Z coordinate value of “N”. The connecting relation between each Y axis board and each Z axis board is indicated by each of light signal input/output lines 300 [1, 1, 1] to 300 [L, M, N].

As obvious from the address value designated to the optical signal input/output line 300, the number of Z axis boards 40 necessary to construct the three-dimensional crossbar network corresponds to the number of combinations of the X and Y coordinate values. Each of the Z axis boards is coupled to a group of specific Y axis boards so that packets can be exchanged among the input/output lines 300 having the same X, Y coordinate values and pulled out from N layers of X-Y planes.

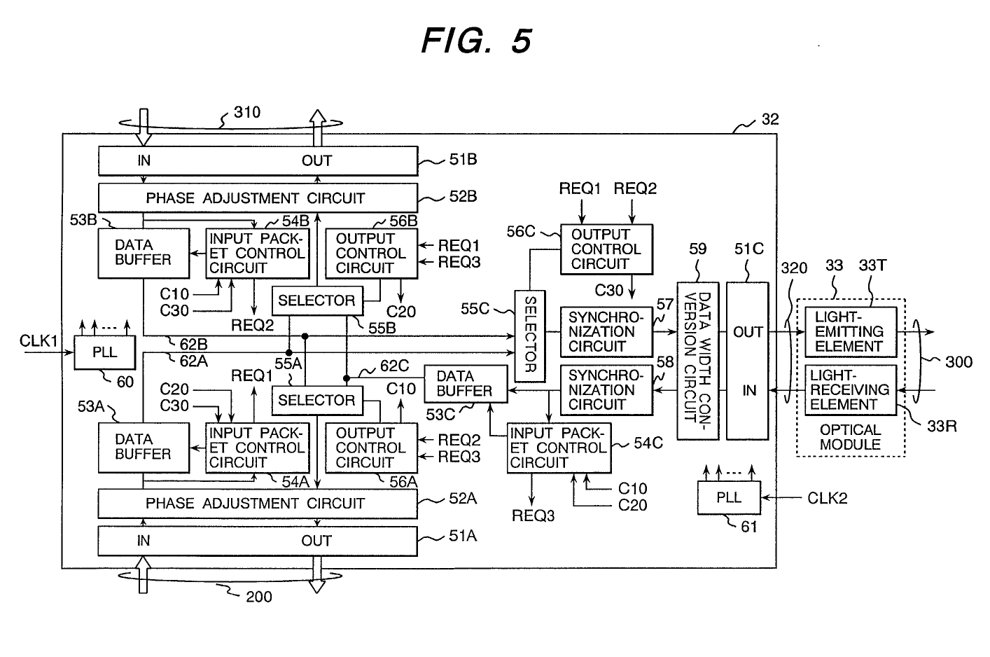

FIG. 5 shows an embodiment of the interface conversion LSI 32 which is mounted on the Y axis board 30 and has the function of exchanging packets between the Y axis crossbar switch 31 and the Z axis crossbar switch 41.

The interface conversion LSI 32 has a first input/output port 51A for accommodating the input/output lines 200 connected to the X axis crossbar switch 21, a second input/output port 51B for accommodating the input/output lines 310 connected to the Y axis crossbar switch 31, and a third input/output port 51C for accommodating input/output lines 320 connected to the optical module 33. Each of the input/output ports has an input port IN and an output port OUT.

CLK1 denotes a reference clock for transferring data by an electric signal between the X axis board 20 and the Y axis board 30. CLK2 denotes a reference clock for transferring data by a light signal between the Y axis board 30 and the Z axis board 40. PLL circuits 60 and 61 generate internal clocks synchronized with the clocks CLK1 and CLK2, respectively.

A packet signal received by the input port IN in the first input/output port 51A is supplied to a data buffer 53A via a phase adjustment circuit 52A. The phase adjustment circuit 52A adjusts the phase of an input signal on the basis of the internal clock generated by the PLL circuit 60 and stores the packet signal supplied from the input port IN as, for example, data of an 8-byte width into the data buffer 53A.

Input packets from second and third input/output ports selected by a selector 55A are outputted to the output port OUT in the first input/output port 51A. The selecting operation of the selector 55A is controlled by an output control circuit 56A. In the following description, the circuit portion constructed by the circuit elements 51A to 56A corresponding to the input/output line 200 will be called a first interface unit, and similar circuit portions corresponding to the input/output lines 310 and 320 will be called second and third interface units, respectively.

The input packet control circuit 54A monitors an output of the phase adjustment circuit 52A, discriminates a start flag indicative of the head of a packet, and extracts a destination Y coordinate set in a predetermined position in the packet header. The input packet control circuit 54A compares the destination Y coordinate value extracted from each packet with a prestored Y coordinate value peculiar to each of the interface conversion LSIs 30. When the Y coordinate values coincide with each other, the input packet control circuit 54A sends an output enable request signal REQ1 of each packet to an output control circuit 56C in the third interface unit. When the Y coordinate values do not coincide with each other, the input packet control circuit 54A sends the output enable request signal REQ1 to an output control circuit 56B in the second interface unit. In response to a packet output enable signal C20 or C30 returned from the output control circuit 56B or 56C, the packet in the data buffer 53A is outputted to an internal bus 62A. The internal bus 62A is connected to an output selector 55B in the second interface unit and an output selector 55C in the third interface unit.

In a manner similar to the first interface unit, the second interface unit has a phase adjustment circuit 52B, a data buffer 53B, an input packet control circuit 54B, the selector 55B, and the output control circuit 56B. To the input port IN in the second interface unit, a packet switched to the y axis direction by the Y axis crossbar switch 31 is supplied. The input packet control circuit 54B, therefore, extracts the destination Z coordinate value from the header of the input packet and compares it with a prestored Z coordinate value of the board address.

When the Z coordinate values coincide with each other, a packet output enable request signal REQ2 is sent to the output control circuit 56A in the first interface unit. When the Z coordinate values do not coincide with each other, the packet output enable request signal REQ2 is sent to the output control circuit 56B in the second interface unit. In response to the packet output enable signal C10 or C30 returned from the output control circuit 56A or 56C, the packet in the data buffer 53B is outputted to an internal bus 62B. The internal bus 62B is connected to the output selector 55A in the first interface unit and the output selector 55C in the third interface unit.

The third interface unit has not only a data buffer 53C, an input packet control circuit 54C, the selector 55C, and the output control circuit 56C but also synchronization circuits 57 and 58 and a data width conversion circuit 59. On receipt of the request signal REQ1 or REQ2, the output control circuit 56C returns the packet output enable signal C30 in accordance with the request generating order and switches the selector 55C, thereby capturing the packet data of the internal bus 62A or 62B corresponding to the request source into the synchronization circuit 57.

The synchronization circuit 57 operates synchronously with an internal clock generated by the PLL circuit 61 to make the data transmission in the third input/output port 51C synchronize with the external clock CLK2. The packet of the 8-byte width outputted from the synchronization circuit 57 is converted into, for example, packet data of 22-bit width by the data width conversion circuit 59. After that, the 22-bit packet data is transmitted from the output port OUT at a speed (frequency) four times as high as that of data transfer in the first and second input/output ports. The packet data transmitted from the output port OUT is converted to a light signal by the laser light emitting element 33T, and the light signal is transmitted to the Z axis board 40 via the optical fiber 300. Between the input/output port 51C and the optical module 33 including the laser light emitting element 33T and the light receiving element 33R, not only the packet data but also a sync clock are transmitted and received.

The packet switched in the Z axis direction by the Z axis crossbar switch 41 is supplied to the light-receiving element 33R via the optical fiber 300 and is converted into an electric signal. After that, the electric signal is supplied to the input port IN in the third input/output port 51C. The packet data received by the input port IN is converted to data of 8-byte width by the data width conversion circuit 59 and resultant data is stored in the data buffer 53C via the synchronization circuit 58. The synchronization circuit 58 operates synchronously with an internal clock generated by the PLL circuit 60.

The input packet control circuit 54C monitors the packet data supplied from the synchronization circuit 58 to the data buffer 53C, extracts the destination Y coordinate in the packet header, and compares the extracted destination Y coordinate with the prestored Y coordinate value peculiar to the interface conversion LSI 30. When the Y coordinate values coincide with each other, a packet output enable request signal REQ3 is sent to the output control circuit 56A in the first interface unit. When the Y coordinate values do not coincide with each other, the packet output enable request signal REQ3 is sent to the output control circuit 56B in the second interface unit. In response to the packet output enable signal C10 or C20 returned from the output control circuit 56A or 56B, the packet data is outputted from the data buffer 53C to an internal bus 62C.

The internal bus 62C is connected to both the output selector 55A in the first interface unit and the output selector 55B in the second interface unit. Since a packet inputted to and outputted from the third input/output port 51C has already been switched in the Y axis direction, the input packet is not transferred to the second interface unit in a practical operation. The output selector 55A in the first interface unit and the output selector 55B in the second interface unit are controlled by the output control circuits 56A and 56B, respectively, in a manner similar to the selector 55C, so that an internal bus which is permitted to output a packet is selected from a pair of the internal buses 62B and 63C and a pair of the internal buses 62A and 62C, respectively.

With the configuration, the interface conversion LSI 32 can perform a packet transferring operation according to the relation between the destination address of the reception packet and the address peculiar to the LSI by the first, second, and third interface units. By applying this to the Y axis board, the packet transfer among arbitrary processor nodes in the three-dimensional array described with reference to FIG. 1 can be realized.

In the interface conversion LSI, the sync clock CLK1 used on the electric signal interface side and the sync clock CLK2 used on the light signal interface side are made independent of each other, between the X axis crossbar switch and the Y axis crossbar switch, a packet is transferred by an electric signal synchronized with the clock CLK1 and, between the Y axis board and the Z axis board, a packet is transferred by a light signal synchronized with the clock CLK2. Consequently, the distributing range of the sync clock CLK1 necessary for the phase adjustment circuit 52 can be localized to, for example, a range in which the sync clock CLK1 can be easily distributed by a coaxial line.

When the interface conversion LSI is used, therefore, by using the sync clock distribution range of the same clock source, for example, a crossbar network including L×M processor nodes constructed by a group of X and Y boards as a unit, a plurality of crossbar networks of different clock sources can be easily connected to each other. A demand of a small-scale crossbar network is responded by a basic unit constructed by the L×M processor nodes. By increasing the number of connection units of the Z axis boards and the optical fibers as necessary, expansion of a crossbar network scale (increase in the number of nodes) according to a demand can be quite easily performed.

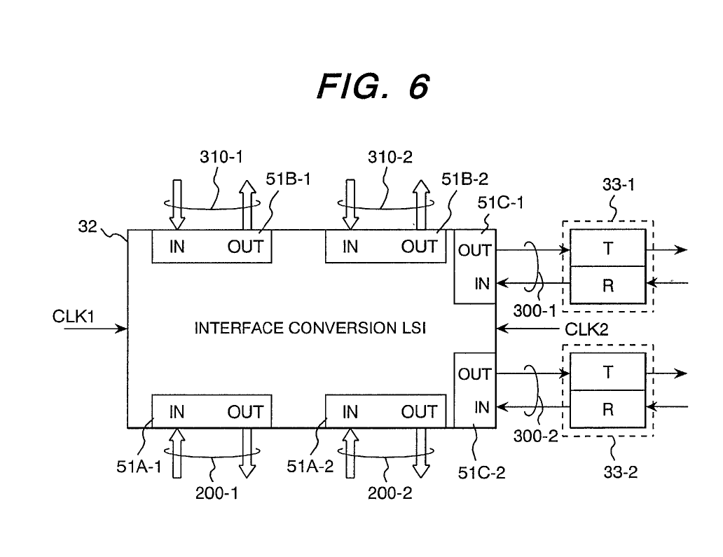

FIG. 6 shows an example of a practical form of the interface conversion LSI 32.

In the example shown here, two sets of the circuit configurations described in FIG. 5 are mounted on the same LSI substrate, and the PLL circuits 60 and 61 are shared by a first circuit unit using input/output ports 51A-1, 51B-1, and 51C-1 and a second circuit unit using input/output ports 51A-2, 51B-2, and 51C-2. As described above, by mounting a plurality of circuit configurations of FIG. 5 on the same LSI substrate to reduce the area occupied by the interface conversion LSIs 32 on the Y axis board 30, the size of the three-dimensional crossbar network can be reduced and the number of connection nodes can be increased.

For the interface conversion LSI 41 mounted on the Z axis board 40, in the circuit configuration of FIG. 5, the first interface unit connected to the input/output line 200 is unnecessary, and only the second interface unit connected to the Z axis crossbar switch and the third interface unit connected to the optical module 33 are necessary. In this case, since no congestion of the output packets occurs on the internal bus, each of interface units can adopt a simple circuit configuration in which the input packet control circuits 54B and 54C, the selectors 55B and 55C, and the output control circuits 56B and 56C are omitted. The interface conversion LSI 41 for the Z axis board can also adopt a device configuration in which plural sets of circuit units are mounted on the same LSI substrate in a manner similar to FIG. 6.

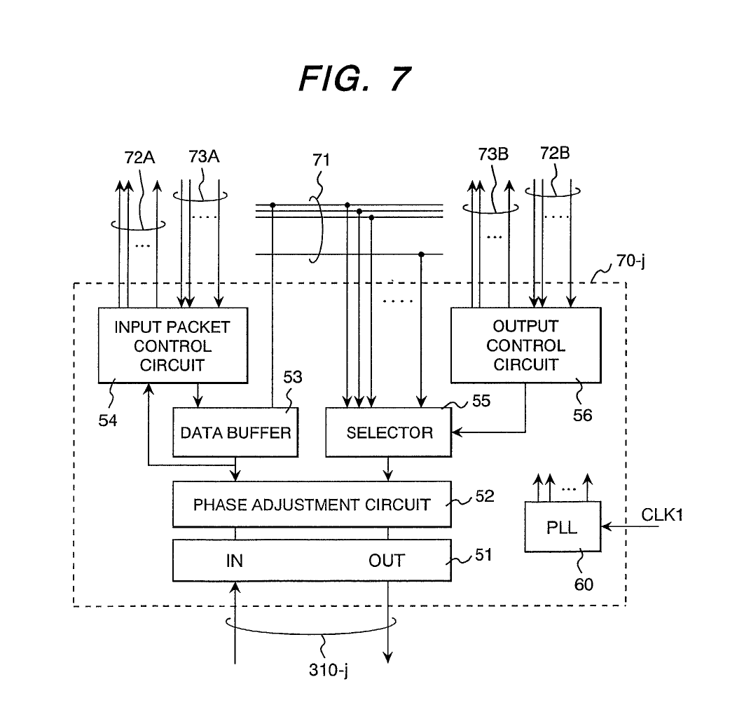

FIG. 7 shows the configuration of the main portion of the Y axis crossbar switch 31.

The Y axis crossbar switch 31 has a configuration in which a plurality of interface units 70-j corresponding to input/output lines 310-j (j=1 to M) are connected to each other via data buses and control lines. The X axis crossbar switch 41 has a similar structure.

Each of the interface units 70-j has an input/output port 51, a phase adjustment circuit 52, a data buffer 53, an input packet control circuit 54, a selector 55, an output control circuit 56, and the PLL circuit 60 for generating internal clocks synchronized with the clock CLK1, and has functions similar to those of the first and second interface units in the interface conversion LSI 32 described with reference to FIG. 5.

Specifically, the input packet control circuit 54 monitors packet data supplied from the phase adjustment circuit 52 to the data buffer 53, extracts the destination Y coordinate from the packet header, and issues the packet output enable request signal REQ to a control line 72A-q connected to an output control line of the q-th interface unit corresponding to the destination Y coordinate value (q). When an output enable signal CNT is received from the q-th interface unit via a control line 73A-q in such a state, the input packet control circuit 54 outputs packet data from the data buffer 53 to a data bus 71.

The data bus 71 is a bus dedicated to each interface unit. A plurality of buses of the number corresponding to the number of interface units are connected to the selector 55. The output control circuit 56 for controlling the selector 55 is connected to the input packet control circuit 54 in the other plurality of interface units 70-j (j=1 to M-1) via control lines 72B and 73B.

When the request signal REQ is received from a control line 72B-k, the output control circuit 56 returns the output enable signal CNT to a corresponding control line 73B-k, and controls the selector 55 so that a bus 71-k corresponding to the control line 72B-k is selected. When a plurality of request signals REQ are received from the control line 72B, the output control circuit 56 returns the output enable signal CNT to the control line 73B-k selected in accordance with a predetermined algorithm, for example, the generation order of request signals.

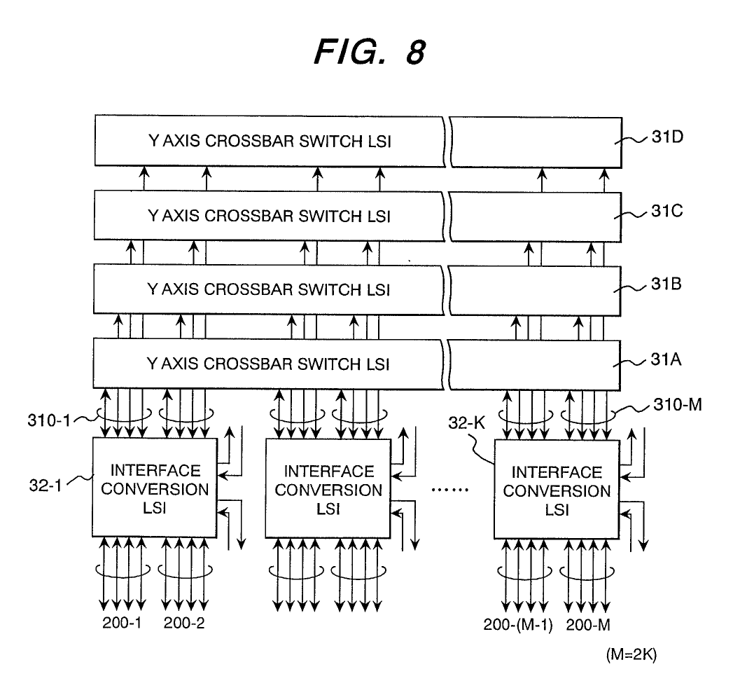

FIG. 8 shows a practical example of the Y axis crossbar switch 31.

The Y axis crossbar switch 31 shown in FIG. 1 transmits and receives packet data, for example, on the 8-byte unit basis to and from each of the interface conversion LSIs 32. In this case, external connection pins of 8 bytes are necessary in the input/output port 51 of each interface unit 70-j shown in FIG. 7. Since a signal line of an 8-byte width is necessary for each connection bus 71 between the interface units, the structure of the LSI is complicated and it becomes difficult to increase the number of ports.

The example shown in FIG. 8 facilitates to form an LSI by reducing the number of external connection pins required to form an LSI from the Y axis crossbar switch 31 and simplifying the structure. It is characterized in that the Y axis crossbar switch 31 is divided into four LSIs 31A to 31D (byte slice structure) so that each input/output port can transmit and receive packet data having a 2-byte width.

In the case where the Y axis crossbar switch 31 adopts the structure, in the second input/output port 51B of each interface conversion LSI 32 shown in FIG. 5, the input/output line 310 connected to the input port IN and the output port OUT is divided into first to fourth input/output lines each having a 2-byte width, so that as shown in FIG. 8, a packet of a 2-byte width is inputted to and outputted from the LSIs 31A to 31D in parallel. Quadruplex information such as the destination node address and data length is preliminarily supplied to each of the packet headers so that each of the crossbar switches 31 can receive a packet of 2-byte width and select a path. The divided structure can be also similarly applied to the X axis crossbar switch 41.

In each of the Y axis board 30 and the Z axis board 40 on which a number of LSIs and external connectors for connecting input/output lines (cables) have to be mounted, for example, the crossbar switch LSIs 31 (31A to 31D) and a group of connectors for connecting the input/output lines (for example, coaxial lines) 200 are disposed on the surface of a multilayer printed wiring board, the group of interface conversion LSIs 32 and connectors for connecting optical boards having thereon a plurality of optical modules 33 are mounted on the back face of the board. The connection (input/output lines 310) between the interface conversion LSIs 32 and the crossbar switch LSIs 31 and the connection between the group of connectors for connecting the input/output lines and the group of interface conversion LSIs 32 are achieved by printed wiring which is penetrating the board and extending from one of the faces to the other face.

It is sufficient to mount the other circuit elements required to construct the Y axis board as follows. For example, an LSI for distributing the clock signal for data transfer to the crossbar switch LSI 31 is mounted on the surface of the board. An LSI for distributing the clock signal to the optical module 33 is mounted on the back face of the board. An LSI necessary for setting an initial value to the crossbar switch LSI 31 and the interface conversion LSI 32, terminating resistors, capacitors for reducing noises are disposed on both faces of the board. A connector for mounting a power supply board is mounted on either one of the faces.

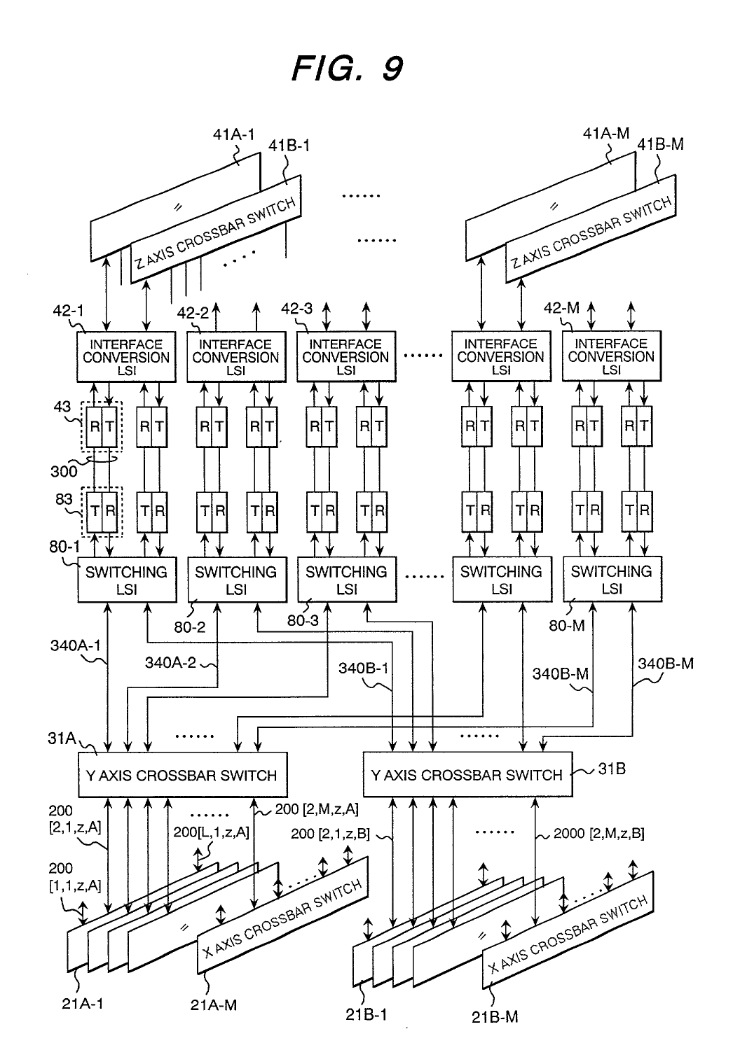

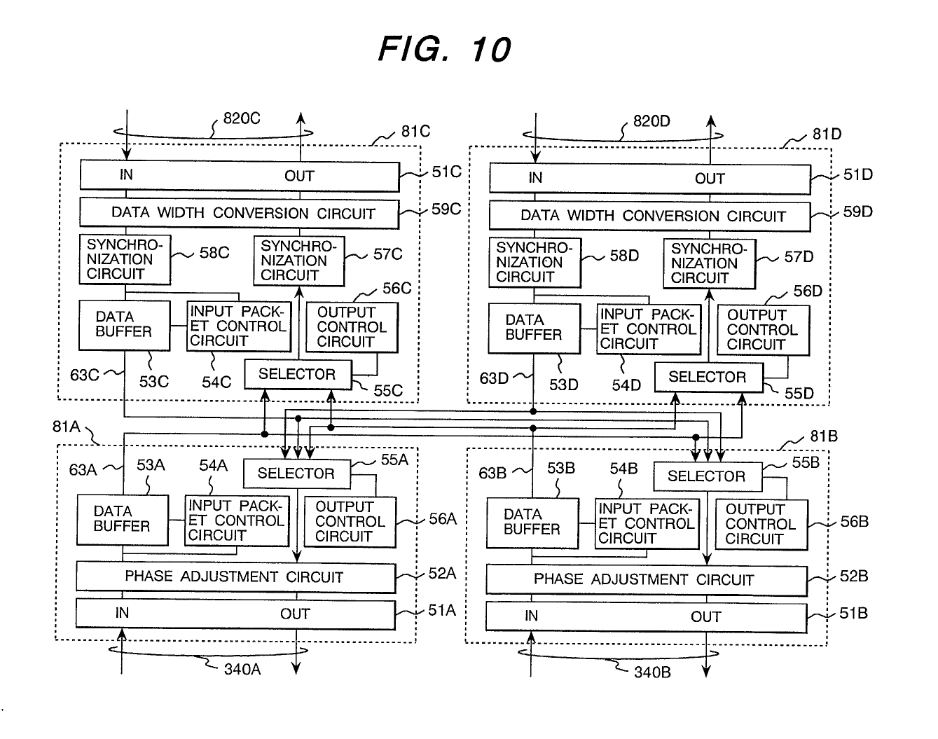

FIG. 9 shows a second embodiment of the three-dimensional crossbar network of the distributed exchanger type according to the invention. The embodiment uses two sets of the three-dimensional crossbar networks described with reference to FIGS. 1 to 4. By interposing switching LSIs 80 having the function of switching four interface units which will be explained with reference to FIG. 10 between the Y axis board 30 and the Z axis board 40, packet transfer is realized from the first crossbar network to the second crossbar network and in the opposite direction.

In FIG. 9, X axis crossbar switches 21A-1 to 21A-M, a Y axis crossbar switch 31A, and Z axis crossbar switches 41A-1 to 41A-M to each of which a reference character A is designated construct a first crossbar network. X axis crossbar switches 21B-1 to 21B-M, a Y axis crossbar switch 31B, and Z axis crossbar switches 41B-1 to 41B-M construct a second crossbar network. Each of the Y axis crossbar switches 31A and 31B corresponds to one of the Y axis boards 30-1-1 to 30-L-N shown in FIG. 4.

In FIG. 9, each of the interface conversion LSIs 42-1 to 42-M includes two ports of circuits on one LSI substrate. Substantially, the interface conversion LSIs 42-1 to 42-M are divided to the group of LSIs for the Z axis crossbar switches 41A-1 to 41A-M and the group of LSIs for the Z axis crossbar switches 41B-1 to 41B-M.

In the embodiment, to each of processor nodes connected to the X axis crossbar switch group, as a node address, coordinate values [x, y, z] in the three-dimensional crossbar network and the identifier (set identifier) [t] of the three-dimensional crossbar network to which each of the nodes belongs are given, and each of the input/output lines 200 of the X axis crossbar switch corresponding to the processor node has an address [x, y, z, t] . In the header of a packet transmitted from each of the processor nodes, the coordinate values of the destination node and the network identifier are set as a destination address. In this case, the identifiers [t] of the first and second crossbar networks are expressed as A and B, respectively.

Each of the Y axis crossbar switches 31A and 31B has a first input/output port group for connection to the X axis crossbar switches, and a second input/output port group for connection to the switching LSIs. The first input/output port group is directly connected to the input/output ports of the X axis crossbar switches via the input/output lines 200. The second input/output port group is connected to the first or second input/output port in each of the switching LSIs 80-1 to 80-M via an input/output line group 340A or 340B.

In the Y axis crossbar switches 31A and 31B, switching in the Y axis direction is performed in accordance with the destination Y coordinate in a packet received from the X axis crossbar switch. A packet required to be switched in the Z axis direction or in networks is transmitted to the output port on the switching LSI side. A packet which is not required to be switched is transmitted to the output port on the X axis crossbar switch side.

Each of the switching LSIs 80-i (i=1 to M) checks the destination address of a packet received from the Y axis crossbar switch 31A. When the destination network identifier [t] is different from a network identifier preliminarily designated to the input port of the reception packet, switching between networks is performed. A packet required to be switched in the Z axis direction is transmitted to the output port on the optical module 83 side. A packet which is not required to be switched in the Z axis direction is transmitted to the output port on the X axis crossbar switch side belonging to the other network. Since the optical module 83 is connected to the optical module 43 on the Z axis board via an optical fiber, in a manner similar to the first embodiment, the switching in the Z axis direction by the Z axis crossbar switch 41A or 41B can be realized.

FIG. 10 shows the configuration of the switching LSI 80.

The switching LSI 80 has two interface units 81A and 81B for transmitting and receiving a packet to and from the Y axis crossbar switch 31, and two interface units 81C and 81D connected to the optical module 83. Packets are exchanged among the interface units. In the case of applying the switching LSI 80 to the crossbar network shown in FIG. 9, the interface units 81A and 81C are used for the first crossbar network, and the interface units 81B and 81D are used for the second crossbar network. Each of the interface units 81A and 81B has components similar to those of the first interface unit in the interface conversion LSI 32 in FIG. 5. Each of the interface units 81C and 81D has components similar to those of the third interface unit in the interface conversion LSI.

In the case of applying the switching LSI 80 to the crossbar network of FIG. 9, the input packet control circuit 54A in the interface unit 81A extracts the destination Z coordinate value (z) and the destination network identifier (t) from the header of a reception packet supplied from the input port IN, and compares them with prestored peculiar z coordinate value and network identifier (A in this case). When both the designation z coordinate value (z) and the destination network identifier (t) do not coincide with the peculiar values, a packet output enable request is sent to the output control circuit 56D in the interface unit 81D on the side of the optical module for the second crossbar network. When an output enable signal is returned, a packet is outputted from the data buffer 53A to the internal bus 63A.

When the destination z coordinate value (z) coincides with the peculiar value and the destination network identifier (t) does not coincide with the peculiar value, a packet output enable request is sent to the output control circuit 56B in the interface unit 81B on the side of the X axis crossbar switch for the second crossbar network. When the destination Z coordinate value (z) does not coincide with the peculiar value and the destination network identifier (t) coincides with the peculiar value, a packet output enable request is sent to the output control circuit 56C in the interface unit 81C on the side of the optical module for the first crossbar network. When an output enable signal is returned, a packet is outputted from the data buffer 53A to the internal bus 63A.

The input packet control circuit 54B in the interface unit 81B stores, as a peculiar value, a network identifier (B in the example) different from that of the input packet control circuit 54A. When both the destination Z coordinate value (z) and the destination network identifier (t) of the reception packet do not coincide with the peculiar values, the input packet control circuit 54B transmits a packet output enable request to the output control circuit 56C in the interface unit 81C on the side of the optical module for the first crossbar network. When the destination Z coordinate value (z) coincides with the peculiar value and the destination network identifier (t) does not coincide with the peculiar value, the input packet control circuit 54B sends a packet output enable request to the output control circuit 56A in the interface unit 81A on the side of the X axis crossbar switch for the first crossbar network. When the destination z coordinate value (z) does not coincide with the peculiar value and the destination network identifier (t) coincides with the peculiar value, the input packet control circuit 54B transmits a packet output enable request to the output control circuit 56D in the interface unit 81D on the side of the optical module for the second crossbar network. When the output enable signal is returned from the output control circuit 56A, 56C, or 56D, a packet is outputted from the data buffer 53B to the internal bus 63B.

To the input port IN in each of the interface units 81C and 81D, the packet which has already been switched in the Y axis and Z axis directions and between networks is supplied. Consequently, it is sufficient to transfer the reception packet to the interface units 81A and 81B on the Y axis crossbar switch side, respectively. When the packet is supplied from the input port IN, it is therefore sufficient for the input packet control circuits 54C and 54D in the interface units 81C and 81D to send a packet output enable request to the output control circuits 56A and 56B of the interface units as destinations, wait for an output enable signal, and output the packet from the data buffers 53C and 53D to the internal buses 63C and 63D, respectively. In the embodiment shown in FIG. 10, however, in order to make the application of the switching LSI 80 general, each of the internal buses 63C and 63D is connected to both the output selectors 55A and 55B of the interface units 81A and 81B, so that the packet transfer destination can be selected.

In the interface units 81A and 81B, the internal buses of the other three interface units are connected to each of the selectors 55A and 55B and one of the interface buses is selected by each of the output control circuits 56A and 56B, thereby enabling reception packets from the three input ports to be selectively transmitted to the output port OUT. In the interface units 81C and 81D, two internal buses 63A and 63B on the Y axis crossbar switch side are connected to each of the selectors 55C and 55D and one of the internal buses is selected by each of the output control circuits 56C and 56D, thereby enabling reception packets from the two input ports to be selectively transmitted to the output port OUT.

According to the configuration of the second embodiment, the switching LSI 80 is used as a switch in the fourth dimension, and the Z axis crossbar switch is commonly used by two sets of the three-dimensional crossbar networks, thereby enabling the number of processor nodes to be doubled without doubling the hardware scale. When the switching LSI 80 also having the crossbar switching function of the distributed exchanger type is also applied to the Z axis crossbar switch side, a crossbar network of a larger number of dimensions can be constructed at a low interconnection cost.

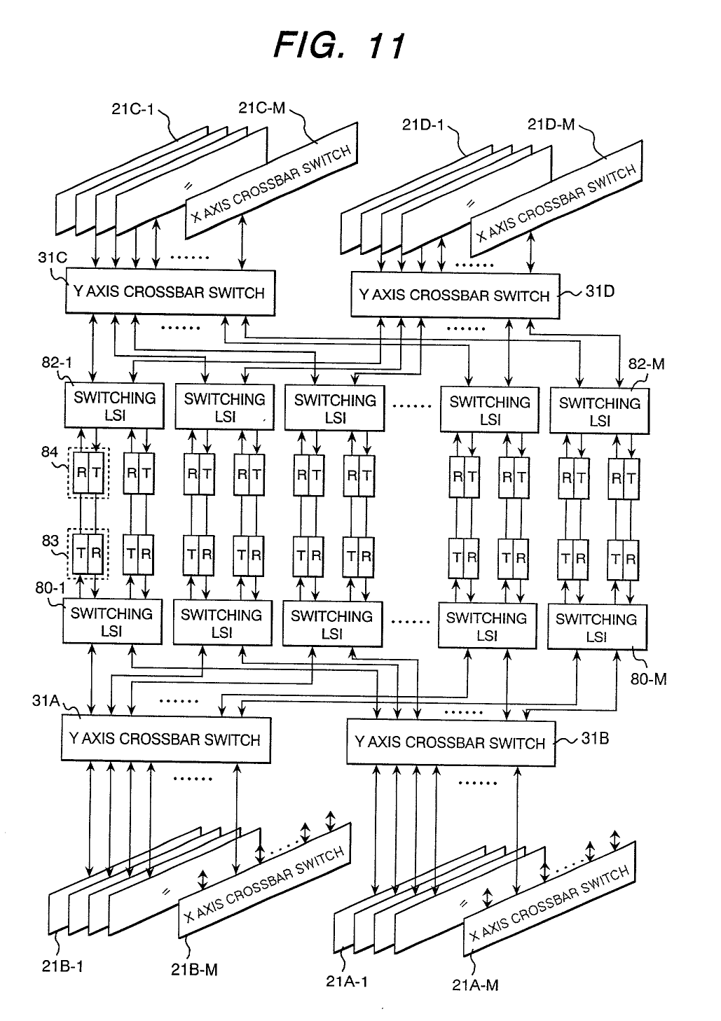

FIG. 11 shows a third embodiment of a three-dimensional crossbar network of a distributed exchanger type according to the invention. The embodiment is characterized by realizing the function of the Z axis crossbar switch 41 in the three-dimensional crossbar network described with reference to FIGS. 1 to 4 by switching LSIs 80. In the diagram, the Y axis crossbar switches 31A, 31B, 31C, and 31D have different Z coordinate values (z), for example, 1, 2, 3, and 4, respectively.

In the third embodiment, in a manner similar to the second embodiment, the input/output ports having the same Y coordinate of the Y axis crossbar switches 31A and 31B are connected to each other via a first group of switching LSIs 80-1 to 80-M. By using the function of switching a packet in the LSI group, switching in the Z axis direction is performed between the Y axis crossbar switches 31A and 31B. Similarly, the Y axis crossbar switches 31C and 31D are connected to each other via a second group of switching LSIs 82-1 to 82-M. By the LSI group, switching in the Z axis direction between the Y axis crossbar switches 31C and 31D is performed. In the first and second switching LSI groups, the LSIs 80-i and 82-i (i=1 to M) having the same Y coordinate are coupled to each other via the optical modules 83 and 84 and the optical fibers 300.

In the interface units 81A and 81B in each of the switching LSI 80-i belonging to the first LSI group, a packet received from the Y axis crossbar switch 31A or 31B is transferred by each input packet control circuit in accordance with the destination Z coordinate value (z) of the packet. When z=1 or 2, the packet is transferred between the interface units 81A and 81B. When z=3, the packet is transferred to the interface unit 81C. When z=4, the packet is transferred to the interface unit 81D.

On the other hand, in the interface units 81A and 81B in each switching LSI 82-i belonging to the second LSI group, a packet received from the Y axis crossbar switch 31C or 31D is transferred in accordance with the destination z coordinate value (z) of the packet. When z=1, the packet is transferred to the interface unit 81C. When z=2, the packet is transferred to the interface unit 81D. When z=3 or 4, the packet is transferred between the interface units 81A and 81B.

According to the embodiment, by using the packet switching function of the first and second switching LSI groups 80 and 82, the three-dimensional crossbar network of the distributed exchanger type having the number of nodes of L×M×4 can be constructed.

As obvious from the above description, according to the invention, by interposing the switching device having an optical interface between at least a part of crossbar switches in the multidimensional crossbar network and the parallel computer system, an effect such that the number of nodes which can be connected can be increased without deteriorating the system performance is produced.

What is claimed is:

1. A multidimensional crossbar network in which a plurality of processor nodes logically, multidimensionally arranged are connected to each other via a plurality of crossbar switches,
wherein a switching device connected to first and second crossbar switches and a third crossbar switch is provided on each packet transmission path connecting the first and second crossbar switches, and by the switching device, a packet is exchanged among the first, second, and third crossbar switches, and interface conversion for performing packet communication by a light signal with any of the crossbar switches is performed.

2. A multidimensional crossbar network having a plurality of X, Y, and Z axis crossbar switches for connecting a plurality of processor nodes logically, multidimensionally arranged to each other,
wherein a switching device for selectively transferring reception packets from the X axis and Y axis crossbar switches to the Z axis crossbar switch is provided on each packet transmission path between the X axis crossbar switch and the Y axis crossbar switch.

3. The multidimensional crossbar network according to claim 2, wherein the switching device comprises:
a first input/output port for communicating packets with one of input/output ports of the X axis crossbar switch;
a second input/output port for communicating packets with one of input/output ports of the Y axis crossbar switch;
a third input/output port for communicating packets with an optical module including a light-emitting element and a light-receiving element; and
means for performing interface conversion of a transmission and reception packet between the first and second input/output ports and the third input/output port,
wherein a part of a packet transmission path between the Y axis crossbar switch and the Z axis crossbar switch is made by an optical fiber coupled to the optical module.

4. The multidimensional crossbar network according to claim 2, wherein the interface conversion means processes a packet transmitted or received by the first and second input/output ports and a packet transmitted or received by the third input/output port with different sync clocks independent of each other.

5. The multidimensional crossbar network according to claim 3, wherein the interface conversion means processes a packet transmitted or received by the first and second input/output ports and a packet transmitted or received by the third input/output port with different sync clocks independent of each other.

6. A multidimensional crossbar network comprised of first and second crossbar networks in each of which a plurality of processor nodes multidimensionally arranged are connected to each other via a plurality of X, Y, and Z axis crossbar switches, wherein each of said crossbar networks comprises:
a plurality of X axis crossbar switches for performing packet exchange in the X axis direction among a plurality of processor nodes having the same Y, Z coordinate values in a three-dimensional coordinate system;
a plurality of Y axis crossbar switch groups for performing packet exchange in the Y axis direction among a plurality of X axis crossbar switches accommodating processor nodes having the same Z coordinate value ina three-dimensional coordinate system; and
a plurality of Z axis crossbar switches for performing packet exchange in the Z axis direction between the plurality of Y axis crossbar switch groups,
two Y axis crossbar switches in positions corresponding to each other in the first and second crossbar networks are coupled to each other via a plurality of switching LSIs disposed on each of packet paths between the Y axis crossbar switches and Z axis crossbar switches, and packet exchange between the first and second crossbar networks is performed by each of the switching LSIs.

7. The multidimensional crossbar network according to claim 6, wherein each of the switching LSIs comprises:
first and second input/output ports for communicating packets with the two Y axis crossbar switches;
third and fourth input/output ports for communicating packets with first and second optical modules each having a light-emitting element and a light-receiving element; and
means for selectively outputting reception packets from the first and second input/output ports to the other one of the first and second input/output ports or the third or fourth input/output port in accordance with header information, and transferring reception packets from the third and fourth input/output ports to the first and second input/output ports, respectively, and
a part of a packet transmission path between each of the Y axis crossbar switches and each of the Z axis crossbar switches is made by an optical fiber coupled to each of the optical modules.

8. A multidimensional crossbar network comprising:
a plurality of X axis crossbar switches for performing packet exchange in the X axis direction among a plurality of processor nodes having the same Y, Z coordinate values in a three-dimensional coordinate system;
a plurality of Y axis crossbar switch groups for performing packet exchange in the Y axis direction among a plurality of X axis crossbar switches accommodating processor nodes having the same Z coordinate value in a three-dimensional coordinate system; and
a plurality of Z axis crossbar switching means for performing packet exchange in the Z axis direction between the plurality of Y axis crossbar switch groups, wherein
each of the Z axis crossbar switching means comprises:
a first group of switching LSIs each having a first input/output port group connected to input/output ports in corresponding X axis coordination positions of a plurality of Y axis crossbar switches having the same X axis coordinate value in a three-dimensional coordinate system, and a second input/output port group connected to a plurality of optical modules each including a light-emitting element and a light-receiving element;
a second group of switching LSIs each having a first input/output port group connected to input/output ports in corresponding X axis coordinate positions in other plurality of Y axis crossbar switches having the same X axis coordinate value in a three-dimensional coordinate system, and a second input/output port group connected to a plurality of optical modules each including a light-emitting element and a light-receiving element; and
a plurality of pairs of optical fibers coupled between the second input/output port group in the first group of switching LSIs and the second input/output port group in the second group of switching LSIs via optical modules.

9. An L×M×N multidimensional parallel computer system comprising:
a plurality of X axis boards each accommodating L processor nodes and an X axis crossbar switch having L external input/output ports;
a plurality of Y axis boards each accommodating a Y axis crossbar switch including M input/output ports and a plurality of switching LSIs connected to the input/output ports of the Y axis crossbar switch, each of said switching LSIs having external input/output ports for connection to the X axis crossbar switch and input/output ports for connection to an optical module for transmitting and receiving a light signal;
a plurality of Z axis boards each accommodating a Z axis crossbar switch having N input/output ports and a plurality of interface conversion LSIs connected to the input/output ports of the Z axis crossbar switch, each of said interface conversion LSIs having input/output ports for connection to an optical module for transmitting and receiving a light signal;
a plurality of electric signal lines connecting the external input/output ports of the X axis crossbar switch and the external input/output ports on the Y axis board; and
a light signal line connecting the optical module for transmitting/receiving a light signal on the Y axis board and the optical module for transmitting/receiving a light signal on the Z axis board.
